(19) United States
(12) Patent Application Publication
(10) Pub. No.: US 2019/0318493 A1
(43) Pub. Date: Oct. 17, 2019

(54) REMOTE DISTANCE ESTIMATION SYSTEM AND METHOD

(71) Applicants: Ali Ebrahimi Afrouzi, San Jose, CA (US); Soroush Mehrnia, Soeborg (DK)

(72) Inventors: Ali Ebrahimi Afrouzi, San Jose, CA (US); Soroush Mehrnia, Soeborg (DK)

(21) Appl. No.: 15/954,335

(22) Filed: Apr. 16, 2018

(51) Int. Cl. G06T 7/55; G01S 17/48; G01S 17/89

(52) U.S. Cl. CPC G06T 7/55; G06T 2207/20221; G01S 17/89; G01S 17/48

(57) ABSTRACT

A distance estimation system comprised of a laser light emitter, two image sensors, and an image processor are positioned on a baseplate such that the fields of view of the image sensors overlap and contain the projections of an emitted collimated laser beam within a predetermined range of distances. The image sensors simultaneously capture images of the laser beam projections. The images are superimposed and displacement of the laser beam projection from a first image taken by a first image sensor to a second image taken by a second image sensor is extracted by the image processor. The displacement is compared to a preconfigured table relating displacement distances with distances from the baseplate to projection surfaces to find an estimated distance of the baseplate from the projection surface at the time that the images were captured.

### CROSS-REFERENCE TO RELATED APPLICATIONS

This is a continuation of U.S. patent application Ser. No. 15/243,783 filed Aug. 22, 2016 which is a Non-provisional Patent Application of U.S. Provisional Patent Application No. 62/208,791 filed Aug. 23, 2015 all of which are herein incorporated by reference in their entireties for all purposes.

### FIELD OF THE INVENTION

This disclosure relates to remote distance estimation systems and methods.

### BACKGROUND OF THE DISCLOSURE

Mobile robotic devices are being used more and more frequently in a variety of industries for executing different tasks with minimal or no human interaction. Such devices rely on various sensors to navigate through their environment and avoid driving into obstacles.

Infrared sensors, sonar and laser range finders are some of the sensors used in mobile robotic devices. Infrared sensors typically have a low resolution and are very sensitive to sunlight. Infrared sensors that use a binary output can determine whether an object is within a certain range but are unable to accurately determine the distance to the object. Sonar systems rely on ultrasonic waves instead of light. Under optimal conditions, some sonar systems can be very accurate; however, sonar systems typically have limited coverage areas: if used in an array, they can produce cross-talk and false readings; if installed too close to the ground, signals can bounce off the ground, degrading accuracy. Additionally, sound-absorbing materials in the area may produce erroneous readings.

Laser Distance Sensors (LDS) are a very accurate method for measuring distance that can be used with robotic devices. However, due to their complexity and cost, these sensors are typically not a suitable option for robotic devices intended for day-to-day home use. These systems generally use two types of measurement methods: Time-of-Flight (ToF) and Triangulation. In ToF methods, the distance of an object is usually calculated based on the round trip of the emission and reception of a signal. In Triangulation methods, usually there is a source and a sensor on the device with a fixed baseline. The emitting source emits the laser beam at a certain angle. When the sensor receives the beam, the sensor calculates the degree at which the beam entered the sensor. Using those variables, the distance traveled by the laser beam may be calculated with triangulation.

A need exists for a more accurate and reliable, yet affordable, method for automatic remote distance measuring.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Embodiments of the present invention introduce new methods and systems for distance estimation. Some embodiments present a distance estimation system including a laser light emitter disposed on a baseplate emitting a collimated laser beam which projects a light point onto surfaces opposite the emitter; two image sensors disposed symmetrically on the baseplate on either side of the laser light emitter at a slight inward angle towards the laser light emitter so that their fields of view overlap while capturing the projections made by the laser light emitter; an image processor to determine an estimated distance from the baseplate to the surface on which the laser light beam is projected using the images captured simultaneously and iteratively by the two image sensors. Each image taken by the two image sensors shows the field of view including the point illuminated by the collimated laser beam. At each discrete time interval, the image pairs are overlaid and the distance between the light points is analyzed by the image processor. This distance is then compared to a preconfigured table that relates distances between light points with distances from the baseplate to the projection surface to find the actual distance to the projection surface.

In embodiments, the assembly may be mounted on a rotatable base so that distances to surfaces may be analyzed in any direction. In some embodiments, the image sensors capture the images of the projected laser light emissions and processes the image. Using computer vision technology, the distances between light points is extracted and the distances may be analyzed.

In embodiments, a method for remotely estimating distance comprises projecting a light from a light emitter onto a surface, capturing images of the projected light by each of at least two image sensors such that each image includes the projected light, overlaying the images captured by the at least two image sensors by a processor to produce a superimposed image, measuring a first distance in the superimposed image between the projected light from each of the captured images, and determining a second distance from a preconfigured table relating distances between the projected light with distances to the surfaces on which the light is projected to estimate distance to the surface on which the light is currently being projected.

In embodiments, a method for remotely estimating distance comprising projecting a light from a light emitter onto a surface, capturing images of the projected light by each of at least two image sensors such that each image includes the projected light, measuring a first distance between the projected light in each of the captured images, and determining a second distance from a preconfigured table relating distances between the projected light with distances to the surfaces on which the light is projected to estimate distance to the surface on which the light is currently being projected.

### BRIEF DESCRIPTION OF DRAWINGS

FIG. 1A illustrates a front elevation view of the distance estimation device, embodying features of the present invention.

FIG. 1B illustrates an overhead view of the distance estimation device, embodying features of the present invention.

FIG. 2 illustrates an overhead view of the distance estimation device and fields of view of the image sensors, embodying features of the present invention.

FIG. 3A illustrates an image captured by a left image sensor embodying features of the present invention.

FIG. 3B illustrates an image captured by a right image sensor embodying features of the present invention.

FIG. 4 illustrates an image captured by a right image sensor and an image captured by a left image sensor overlaid embodying features of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a computer and/or a dedicated computing device when appropriately programmed and may include a combination of a computer/computing device and dedicated/programmable circuits adapted for the various tasks pertaining to embodiments of the invention. The disclosure described herein is directed generally to one or more processor-automated methods and/or systems that estimate distance of a device with an object also known as distance estimation systems.

Embodiments described herein include a distance estimation system including a laser light emitter disposed on a baseplate emitting a collimated laser beam creating an illuminated, such as a light point or projected light point, on surfaces that are substantially opposite the emitter; two image sensors disposed on the baseplate, positioned at a slight inward angle towards to the laser light emitter such that the fields of view of the two image sensors overlap and capture the projected light point within a predetermined range of distances, the image sensors simultaneously and iteratively capturing images; an image processor overlaying the images taken by the two image sensors to produce a superimposed image showing the light points from both images in a single image; extracting a distance between the light points in the superimposed image; and, comparing the distance to figures in a preconfigured table that relates distances between light points with distances between the baseplate and surfaces upon which the light point is projected (which may be referred to as ‘projection surfaces’ herein) to find an estimated distance between the baseplate and the projection surface at the time the images of the projected light point were captured.

In some embodiments, the preconfigured table may be constructed from actual measurements of distances between the light points in superimposed images at increments in a predetermined range of distances between the baseplate and the projection surface.

In embodiments, each image taken by the two image sensors shows the field of view including the light point created by the collimated laser beam. At each discrete time interval, the image pairs are overlaid creating a superimposed image showing the light point as it is viewed by each image sensor. Because the image sensors are at different locations, the light point will appear at a different spot within the image frame in the two images. Thus, when the images are overlaid, the resulting superimposed image will show two light points until such a time as the light points coincide. The distance between the light points is extracted by the image processor using computer vision technology, or any other type of technology known in the art. This distance is then compared to figures in a preconfigured table that relates distances between light points with distances between the baseplate and projection surfaces to find an estimated distance between the baseplate and the projection surface at the time that the images were captured. As the distance to the surface decreases the distance measured between the light point captured in each image when the images are superimposed decreases as well.

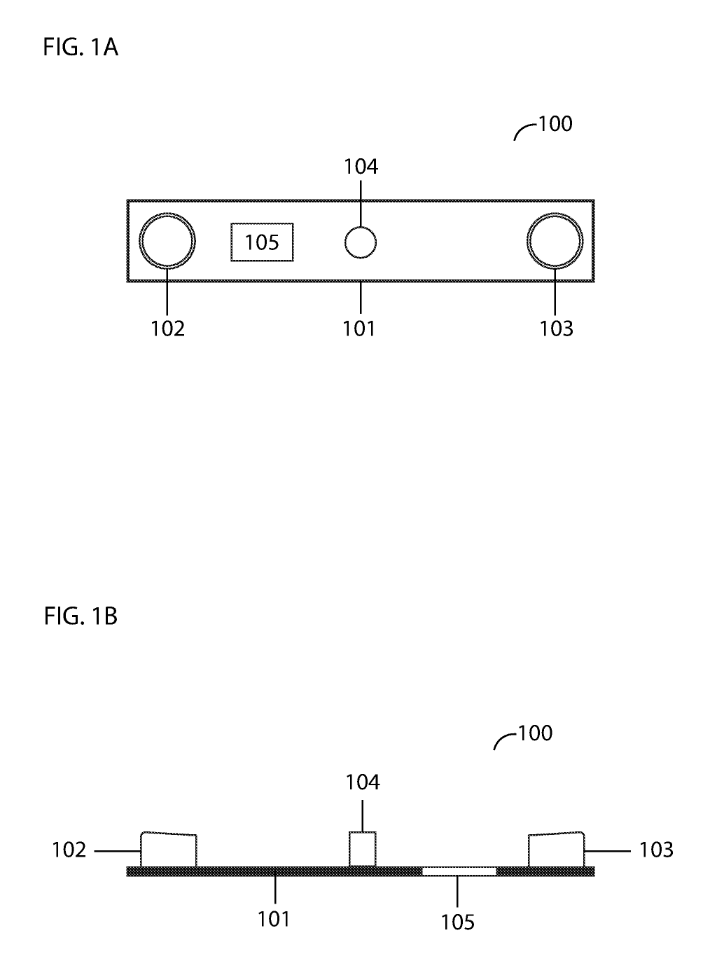

Referring to FIG. 1A, a front elevation view of an embodiment of distance estimation system 100 is illustrated. Distance estimation system 100 is comprised of baseplate 101, left image sensor 102, right image sensor 103, laser light emitter 104, and image processor 105. The image sensors are positioned with a slight inward angle with respect to the laser light emitter. This angle causes the fields of view of the image sensors to overlap. The positioning of the image sensors is also such that the fields of view of both image sensors will capture laser projections of the laser light emitter within a predetermined range of distances. Referring to FIG. 1B, an overhead view of remote estimation device 100 is illustrated. Remote estimation device 100 is comprised of baseplate 101, image sensors 102 and 103, laser light emitter 104, and image processor 105.

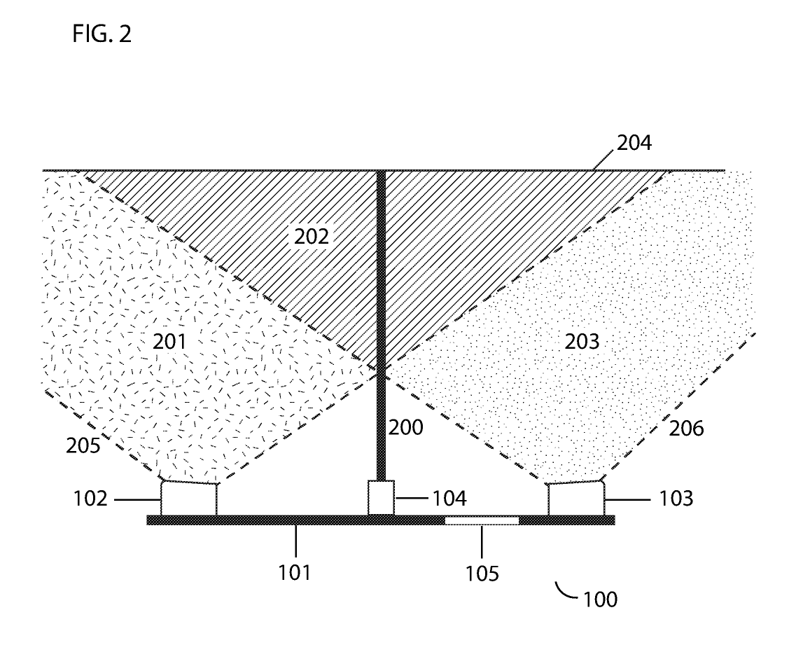

Referring to FIG. 2, an overhead view of an embodiment of the remote estimation device and fields of view of the image sensors is illustrated. Laser light emitter 104 is disposed on baseplate 101 and emits collimated laser light beam 200. Image processor 105 is located within baseplate 101. Area 201 and 202 together represent the field of view of image sensor 102. Dashed line 205 represents the outer limit of the field of view of image sensor 102. (It should be noted that this outer limit would continue on linearly, but has been cropped to fit on the drawing page.) Area 203 and 202 together represent the field of view of image sensor 103. Dashed line 206 represents the outer limit of the field of view of image sensor 103. (It should be noted that this outer limit would continue on linearly, but has been cropped to fit on the drawing page.) Area 202 is the area where the fields of view of both image sensors overlap. Line 204 represents the projection surface. That is, the surface onto which the laser light beam is projected.

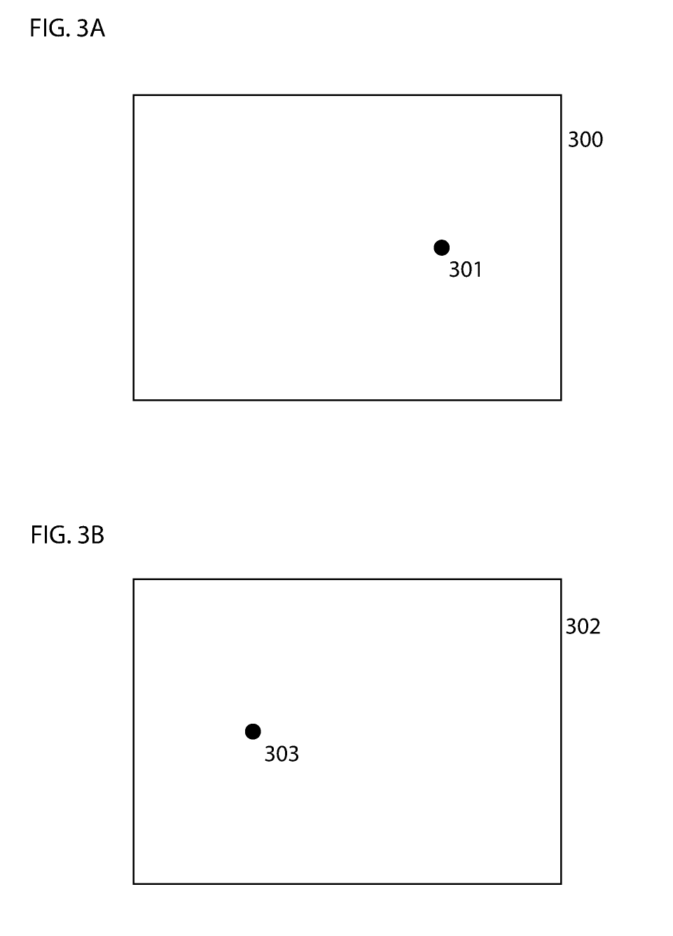

The image sensors simultaneously and iteratively capture images at discrete time intervals. Referring to FIG. 3A, an embodiment of the image captured by left image sensor 102 (in FIG. 2) is illustrated. Rectangle 300 represents the field of view of image sensor 102. Point 301 represents the light point projected by laser beam emitter 104 as viewed by image sensor 102. Referring to FIG. 3B, an embodiment of the image captured by right image sensor 103 (in FIG. 2) is illustrated. Rectangle 302 represents the field of view of image sensor 103. Point 303 represents the light point projected by laser beam emitter 104 as viewed by image sensor 102. As the distance of the baseplate to projection surfaces increases, light points 301 and 303 in each field of view will appear further and further toward the outer limits of each field of view, shown respectively in FIG. 2 as dashed lines 205 and 206. Thus, when two images captured at the same time are overlaid, the distance between the two points will increase as distance to the projection surface increases.

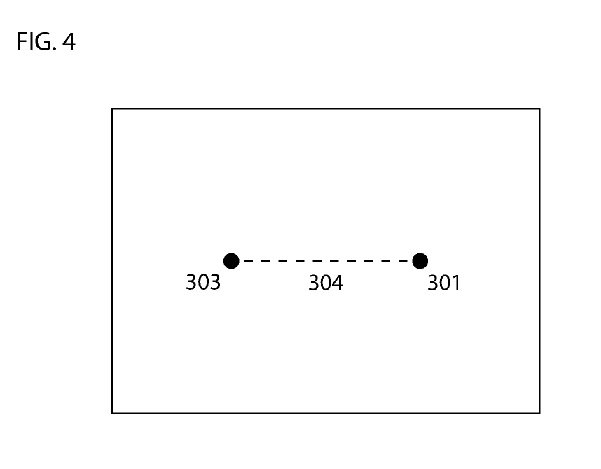

Referring to FIG. 4, the two images from FIG. 3A and FIG. 3B are shown overlaid. Point 301 is located a distance 304 from point 303. The image processor 105 (in FIG. 1A) extracts this distance. The distance 304 is then compared to figures in a preconfigured table that co-relates distances between light points in the superimposed image with distances between the baseplate and projection surfaces to find an estimate of the actual distance from the baseplate to the projection surface upon which the images of the laser light projection were captured.

In some embodiments, the distance estimation device further includes a band-pass filter to limit the allowable light.

In some embodiments, the baseplate and components thereof are mounted on a rotatable base so that distances may be estimated in 360 degrees of a plane.

The foregoing descriptions of specific embodiments of the invention have been presented for purposes of illustration and description. They are not intended to be exhaustive or to limit the invention to the precise forms disclosed. Obviously, many modifications and variations are possible in light of the above teaching.

We claim:

1. A method for remotely estimating distance comprising:
projecting a light from a light emitter onto a surface;
capturing images of the projected light by each of at least two image sensors such that each image includes the projected light;
overlaying the images captured by the at least two image sensors by a processor to produce a superimposed image;
measuring a first distance in the superimposed image between the projected light from each of the captured images; and
determining a second distance from a preconfigured table relating distances between the projected light with distances to the surfaces on which the light is projected to estimate distance to the surface on which the light is currently being projected.

2. The method of claim 1, wherein the light emitter is a laser light emitter.

3. The method of claim 1, wherein the light emitted is a light point.

4. The method of claim 1, wherein the light emitted is a light line.

5. The method of claim 1, wherein the surface onto which the light is projected is opposite the light emitter.

6. The method of claim 1, wherein the at least two image sensors are positioned such that each image includes the light for a range of distances.

7. The method of claim 1, wherein the superimposed image is a single image produced from the captured images.

8. The method of claim 1, wherein the preconfigured table comprises actual measurements of distances in the superimposed image between the projected light in each of the captured images at incremental distances from the surface on which the light is projected.

9. The method of claim 1, wherein the light emitter and the at least two image sensors are disposed on a baseplate.

10. A method for remotely estimating distance comprising:
projecting a light from a light emitter onto a surface;
capturing images of the projected light by each of at least two image sensors such that each image includes the projected light;
measuring a first distance between the projected light in each of the captured images; and
determining a second distance from a preconfigured table relating distances between the projected light with distances to the surfaces on which the light is projected to estimate distance to the surface on which the light is currently being projected.

11. The method of claim 10, wherein the light emitter is a laser light emitter.

12. The method of claim 10, wherein the light emitted is a light point.

13. The method of claim 10, wherein the light emitted is a light line.

14. The method of claim 10, wherein the surface onto which the light is projected is opposite the light emitter.

15. The method of claim 10, wherein the at least two image sensors are positioned such that each image includes the light for a range of distances.

16. The method of claim 10, wherein the first distance is determined by superimposing the captured images and determining the distance between the projected light in each of the captured images by a processor of the robotic device.

17. The method of claim 10, wherein the first distance is determined by measuring in each of the captured images the distance of the projected light to a common point contained in each of the two images and finding the difference between the two distances measured by the processor of the robotic device.

18. The method of claim 10, wherein the preconfigured table comprises actual measurements of distances in the superimposed image between the projected light in each of the captured images at incremental distances from the surface on which the light is projected.

19. The method of claim 10, wherein the light emitter and the at least two image sensors are disposed on a baseplate.
